(19) United States
(12) Patent Application Publication
(10) Pub. No.: US 2022/0370945 A1
(43) Pub. Date: Nov. 24, 2022

(54) AIR FILTER WITH INTEGRATED SEAL LIP

(71) Applicant: ELSÄSSER FILTERTECHNIK GMBH, Nufringen (DE)

(72) Inventor: Klaus MÖSSINGER, Nufringen (DE)

(73) Assignee: ELSÄSSER FILTERTECHNIK GMBH, Nufringen (DE)

(21) Appl. No.: 17/773,388

(22) PCT Filed: Oct. 2, 2020
(86) PCT No.: PCT/DE2020/100852

§ 371 Date: Apr. 29, 2022

(30) Foreign Application Priority Data
Nov. 4, 2019 (DE) 102019129692.7

(51) Int. Cl. B01D 46/24; B01D 46/00; F02M 35/024

(52) U.S. Cl. CPC B01D 46/2414; B01D 46/001; B01D 46/0046; F02M 35/02416; F02M 35/02483; B01D 46/0005; B01D 2271/027; B01D 2279/60; B01D 2277/30; B01D 2265/02; B01D 2265/05

(57) ABSTRACT

The invention is based on an air filter with a filter element (28), a substantially cylindrical filter housing (12) with an unfiltered air inlet (18) and a filtered air outlet (20) arranged substantially concentrically on a first end face of the filter housing (12), wherein an extension tube (22) projects into the interior of the filter housing (12) at the filtered air outlet (20) and the filter element (28) comprises a first end plate (24) which can be plugged onto the extension tube (22).

It is proposed that the first end plate (24) is formed of plastic and comprises a sealing lip (30) formed thereon and projecting radially inwardly, which sealing lip (30) rests against the extension tube (22) in the plugged-on state.

The invention relates to an air filter, in particular for the intake air for internal combustion engines.

The document DE 17912679 discloses an air filter with a filter housing and a substantially cylindrical filter element with an inner support tube is known, wherein the inner filter element is arranged coaxially in the filter housing. The filter element is sealed with regard to the filter housing by annular end plates made of polyurethane. The end plate can be pushed onto an inner section of an outlet part of the filter housing, where it creates a force-fit connection between the filter element and the outlet part.

As is known, the filter elements of air filters are replaced after a certain period of operation.

In regular operation, the filter element prevents dirt particles from entering from the raw area of the filter into a clean area of the filter. Over time, however, encrusted dirt can collect on the walls of the filter housing, especially at the transition to the end plate of the filter element. When a dirty filter element is removed, parts of the incrustations can come loose, collect at the bottom of the filter housing and, after a new filter element has been inserted, enter the clean area and/or impair the sealing effect of the end plate. Under certain circumstances, the incrustations can further generate an adhesive force, requiring a considerable amount of force to loosen the non-positive connection between the filter element and the outlet part.

From DE 59602286 D1 and DE 4241586 A, further generic air filters are known which have two-part filter housings. The two filter housing parts are connected to each other by metal brackets arranged on the side of the filter housing, which have to be loosened or closed again to replace the filter element. The metal clamps must be accessible to the user, and corresponding installation space must be provided at the side of the filter housing in the engine compartment, which can be difficult under certain circumstances.

Furthermore, sufficient installation space must be provided in the axial direction to allow the filter element to be pulled out and inserted into the lower part of the filter housing.

The invention is therefore based on the problem of creating a filter with an easily replaceable filter element that requires little installation space and/or prevents dirt from entering a clean area.

The problem is solved by an air filter having the features of claim 1 and a filter element for use in such an air filter. Advantageous embodiments of the invention are disclosed in the dependent claims.

The invention relates to an air filter having a substantially cylindrical filter housing with an inlet for unfiltered air and am outlet for filtered air arranged substantially concentrically on a first end face of the filter housing, wherein an extension tube projects into the interior of the filter housing at the filtered air outlet and the filter element comprises a first end plate which can be fitted onto the extension tube. The extension tube may be part of the housing or may be the end portion of a pressed-in or otherwise attached clean air stub.

It is proposed that the first end plate is made of plastic and comprises a sealing lip formed thereon and projecting radially inwards, which in the fitted state bears against the extension tube. The sealing lip can be pulled off the attachment tube with little force, even in the case of heavy soiling, and adhesion, as can occur with force-fit sealing beads, can be prevented. The sealing lip also effectively prevents the penetration of dirt particles into the clean area of the filter.

In a particularly advantageous embodiment of the invention, it is proposed that the sealing lip protrudes radially inwards and axially in the direction of the first end face from a base ring of the first end plate. Compared to embodiments in which the sealing lip is inclined away from the first end face in axial section, this can further simplify the removal of the filter element.

It is further proposed that the first end plate comprises a spacer structure projecting axially in the direction of the first end face, which projects axially beyond the sealing lip. This can prevent the sealing lip from being damaged or permanently deformed during transport or installation of the filter element.

In a further development of the invention, it is proposed that the axial height of the spacer structure is selected such that a gap remains between the spacer structure and the filter housing wall in an assembled state of the filter element. This ensures that the filter element can expand freely in the axial direction, e.g. by swelling in the event of moisture or thermal expansion.

It is further proposed that the first end plate comprises a second sealing lip formed thereon and projecting radially outwards, which in the fitted state bears against a filter housing wall or a separating tube. In this way, the sealing properties can be further improved.

It is further proposed that the filter element comprises a support ring arranged on a radially outer surface of the filter element for radially and/or axially fixing the filter element in the filter housing. By supporting the filter element radially outwardly on the filter housing, a substantially force-free and static connection can be ensured in the region of the sealing lip.

In a further embodiment of the invention, it is proposed that the support ring is formed integrally with a second end plate which is arranged at the end of the filter element opposite the first end plate. The one-piece design allows manufacturing costs to be kept low.

In a preferred embodiment of the invention, the first end plate and/or the second end plate are bonded to a filter bellows of the filter element.

In a particularly preferred embodiment of the invention, the first end plate is made of a non-porous soft plastic.

Conceivable materials for the end plates are, in particular, polyolefins, such as polyethylene and polypropylene, or other thermoplastics, such as acrylonitrile-butadiene-styrene (ABS), polyamides (PA), polylactate (PLA), polymethyl methacrylate (PMMA), polycar-bonate (PC), polyethylene terephthalate (PET), polyethylene (PE), polypropylene (PP), polystyrene (PS), polyetheretherketone (PEEK) and polyvinyl chloride (PVC).

Further features and advantages are apparent from the following figure description. The entire description, claims and figures disclose features of the invention in specific embodiments and combinations. The person skilled in the art will also consider the features individually and combine them into further combinations or sub-combinations to adapt the invention, as defined in the claims, to his needs or to specific fields of application.

In this regard, show:

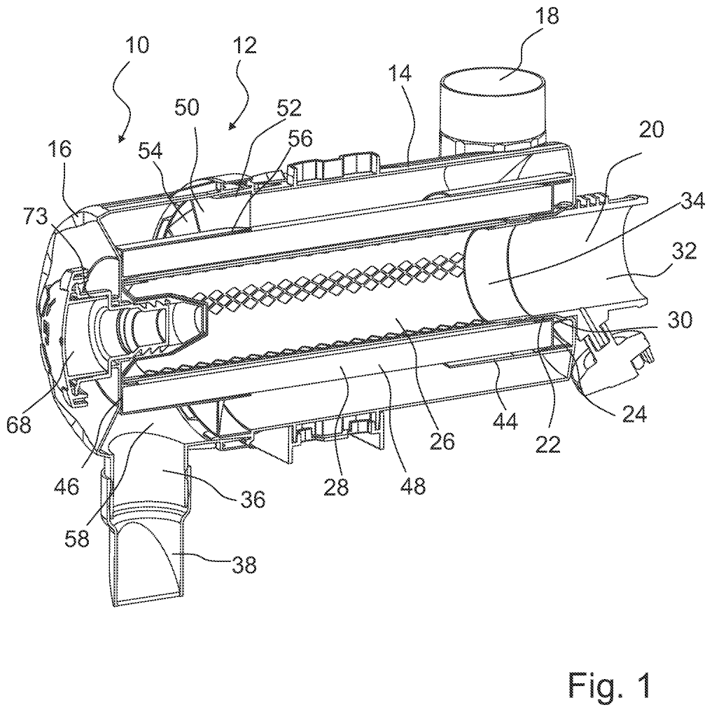

FIG. 1 a sectional view of an air filter according to a first embodiment example of the invention;

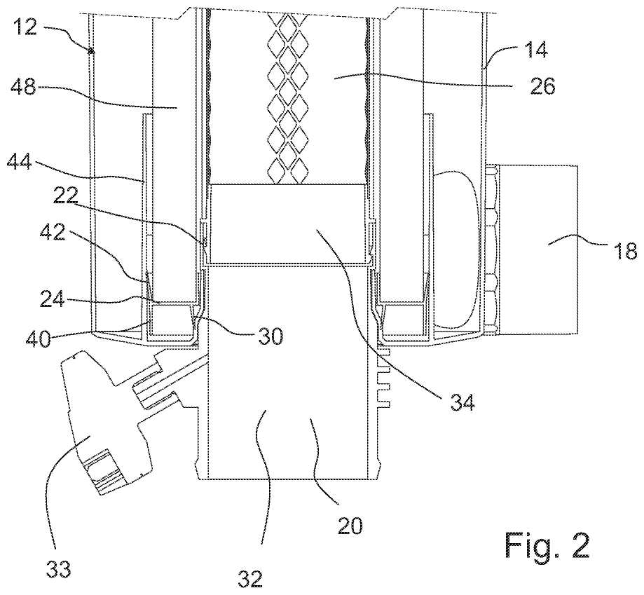

FIG. 2 a detailed view of a bottom portion of a housing base of the air filter of FIG. 1 in a sectional view;

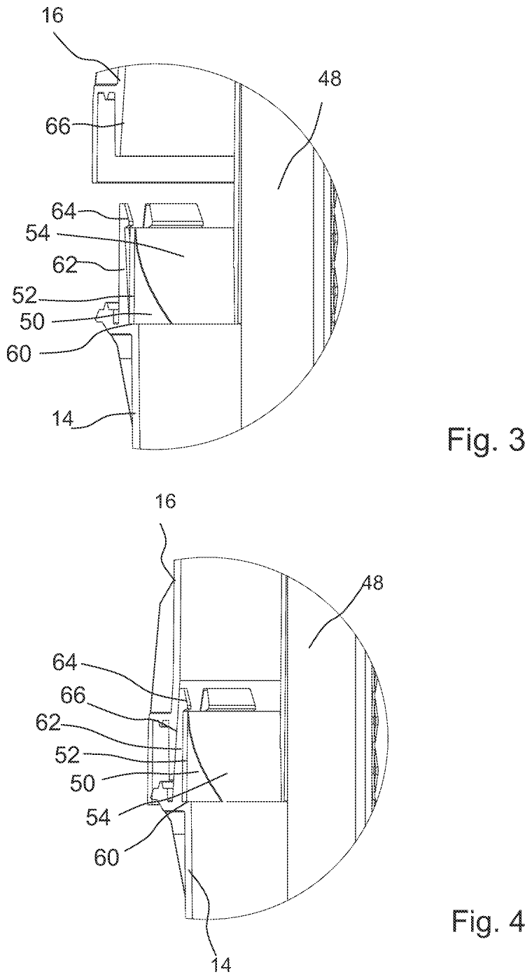

FIG. 3 a detail view of a housing cover of the air filter of FIGS. 1 and 2 in a sectional view;

FIG. 4 a detail view of a housing cover of the air filter of FIGS. 1 and 2 in an opened state of a sectional view;

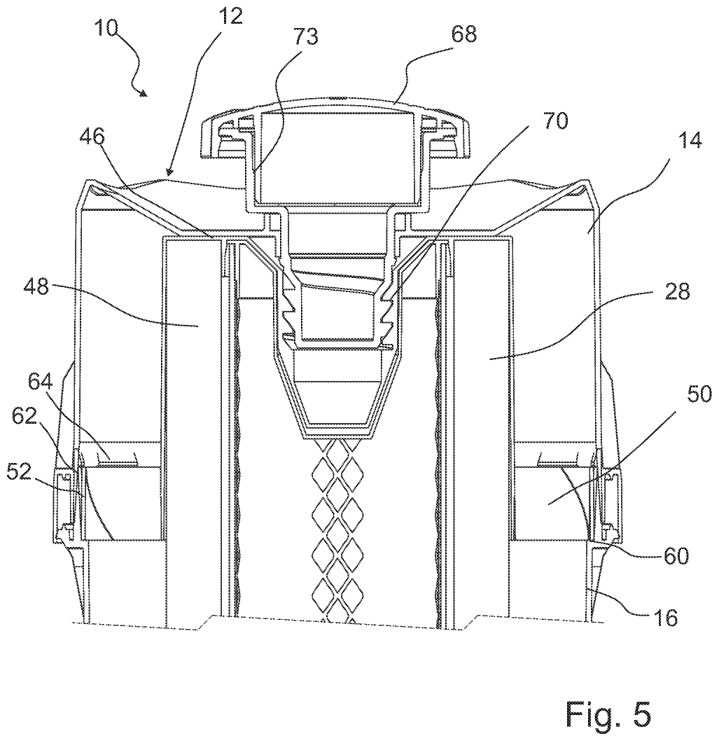

FIG. 5 a detailed view of a housing cover of the air filter from FIGS. 1 and 2 in a closed state of a sectional view;

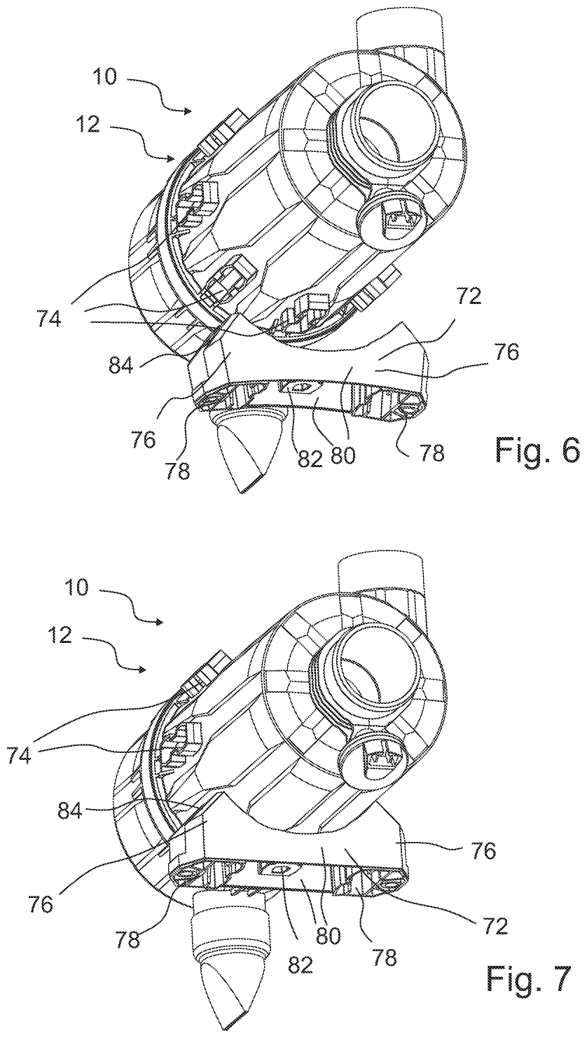

FIG. 6 a perspective view of the air filter from FIGS. 1-5 with an attached holder;

FIG. 7 a perspective view of the air filter from FIGS. 1-5 with a detached holding member;

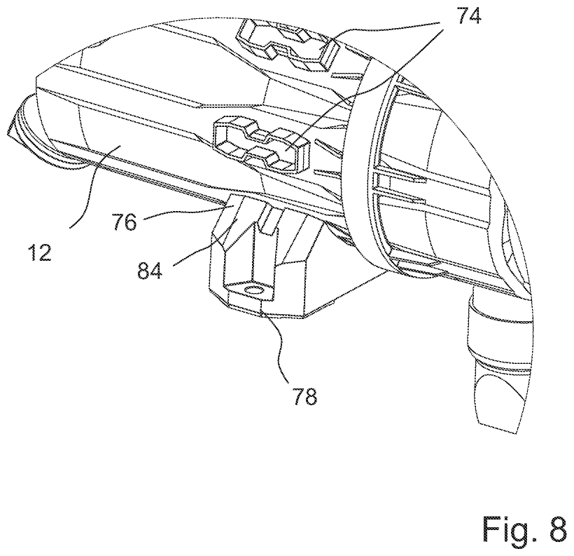

FIG. 8 a detailed view of the holder from FIGS. 6 and 7; and

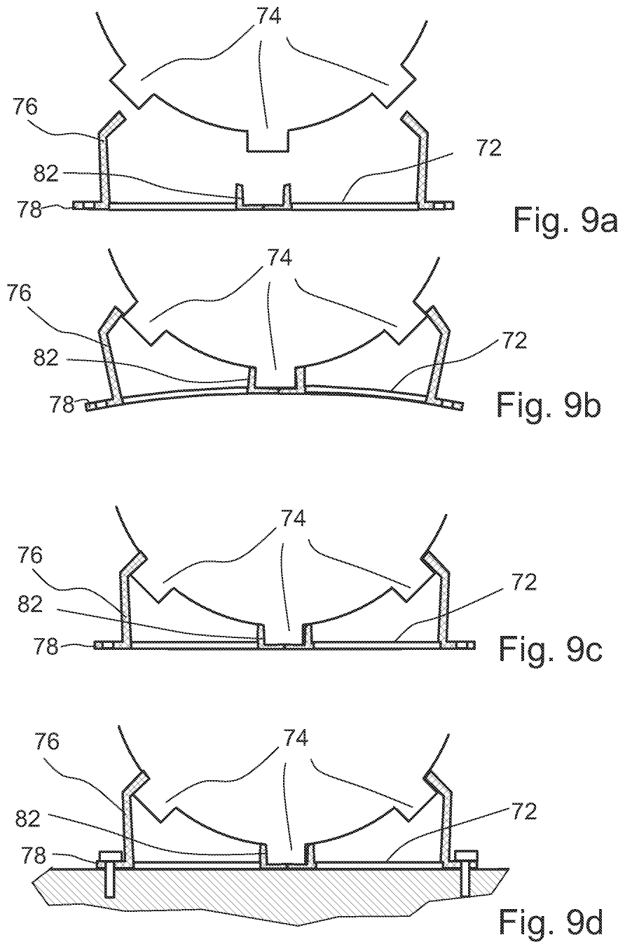

FIGS. 9a-9d schematic illustrations for mounting the air filter according to the invention.

FIGS. 1-8 show an air filter 10 according to a first embodiment of the invention.

FIG. 1 shows the air filter 10 in a sectional view. The air filter 10 comprises a substantially cylindrical filter housing 12 with a housing base 14 and a housing cover 16. An unfiltered air inlet 18 and a filtered air outlet 20 arranged substantially concentrically on a first end face of the filter housing 12 are provided in the housing base 14, wherein an extension tube 22 projects into the interior of the filter housing 12 at the filtered air outlet 20 and the filter element comprises a first end plate 24 which can be plugged onto the extension tube 22. The first end plate 24 is made of polypropylene plastic.

A discharge wall (dip tube) is provided in the area of the unfiltered air inlet 18. In conjunction with the unfiltered air inlet 18, which enters the filter housing 12 tangentially, a swirling flow of unfiltered air is formed. This causes coarse dust particles to be separated, whereby these coarse dust particles pass downwards along the inner wall of the filter and are led into the open air via a dust discharge opening, which is closed by a known dust discharge valve.

In the filter housing 12, a safety element 26 is arranged fixed to the housing, which comprises a metal grid (in particular an expanded metal grid) and a fleece layer.

A filter element 28 is fitted over the safety element 26. This filter element 28 carries the first end plate 24 on its first end face. A radially inwardly projecting sealing lip 30 is integrally formed on the end plate 24, which, in the fitted state, rests against the extension tube 22 and engages around it in a sealing manner.

The sealing lip 30 projects from a base ring of the first end plate 24 and, in the axial section shown in FIG. 1, is inclined axially from the base ring in the direction of the first end face of the filter housing 12. The attachment tube 22 comprises an outer profile which widens in the direction of the first end face of the filter housing 12, so that the sealing lip 30 is guided and widened when the filter element 28 is pushed onto the attachment tube 22. During this push-on movement, any dirt particles adhering to the outer profile of the extension tube 22 are pushed away and cannot enter the clean area of the air filter 10.

A connection piece 32 for a bend or a straight clean air outlet 20 is arranged in the inner profile of the extension tube 22, in which a maintenance switch 33 is provided. The connection piece 32 can be mounted freely in the cylindrical inner profile of the attachment pipe 22 in the circumferential direction. An end ring 34 of the safety element 26 is connected to the connection piece 32 via a snap-in connection. The attached filter element 28 prevents the latching tabs of the connection piece 32 from deflecting radially outward, so that the safety element 26 is locked to the connection piece 32.

When assembling the entire filter, the safety element 26 is first inserted, then the filter element 28 is slid over it and the housing cover 16 is put on.

The filter housing 12 further comprises a dust discharge opening 36 with a dust discharge valve 38 attached thereto (FIG. 1). This dust discharge valve 38 has a lip-opening in the lower region. In the event of pressure pulsations that act back into the filter housing 12 via the clean air outlet 20, starting from an internal combustion engine, this lip-opening opens briefly so that the dirt collected in the dust discharge valve 38 or the lower region of the housing cover 16 can escape.

FIG. 2 shows a detail view of a bottom area of a housing base of the air filter of FIG. 1 in a sectional view. The first end plate 24 has a cylindrical ring-shaped spacer structure 40 axially recessed in the direction of the first end face, which axially protrudes over the sealing lip 30. The axial height of the spacer structure 40 is selected to leave a gap between the spacer structure 40 and the filter housing wall in an assembled condition of the filter element 28. During transportation and assembly of the filter element 28, the spacer structure 40 protects the sealing lip 30 while the gap allows axial expansion of the filter element 28.

The first end plate 24 includes a second sealing lip 42 formed thereon and projecting radially outwardly at an angle toward the first end face of the filter housing 12, which sealing lip 42 abuts an inner surface of a separation tube 44 when mounted.

FIGS. 3, 4 and 5 show various one detail views of a housing cover of the air filter of FIGS. 1 and 2 in a sectional view.

The filter element 28 includes a second end plate 48 disposed at the end of the filter element 28 opposite the first end plate 24. Like the first end plate 24, the second end plate 48 is formed from plastic and is bonded to a filter bellows 48 of the filter element 28, which is formed from cellulose.

The second end plate 24 includes a support ring 50 disposed on a radially outer surface of the filter element 28 for radially and axially securing the filter element 28 in the filter housing 12.

The support ring 50 is integrally formed with the second end plate 46. The support ring 50 includes an outer ring 52 connected to an inner ring 56 by radially extending ribs 54. The ribs 54 are arranged obliquely in the direction of the cyclone flow and delimit a dust collection area 58 in front of the dust discharge opening 36 and the dust discharge valve 38.

The support ring 50 is adapted to rest on a shoulder 60 on the inner periphery of the housing base 14 in an assembled state (FIG. 4 and FIG. 5).

At an upper edge of the housing base 14, there are retaining tabs 62 having projections 64 projecting radially inward that are disposed at a height to engage around the support ring 50 when the support ring 50 rests on the shoulder 60.

The housing cover 16 has a tapered inner surface 66 at its lower edge, which is shaped such that when the cover is in the mounted configuration, deflection of the retaining tabs 62 in a radially outward direction is blocked by the inner surface 66. The support ring 50 is therefore fixed axially between the shoulder 60 and the projections 64.

Due to the taper of the inner surface 66, the retaining tabs 62 are deflected radially inwardly when the housing cover 16 is mounted, and the support ring 50 is radially fixed between the inner surfaces of the retaining tabs 62.

Since the support ring 50 is formed integrally with the second end plate 46, which is arranged at an end of the filter element 28 facing the housing cover 16, direct force transmission from the second end plate 46 to the housing base 14 is made possible when the support ring 50 is fixed. A groove for receiving a sealing ring (not shown) is also provided at the lower edge of the housing cover 16.

A connecting screw 68 is provided in the housing cover 16 for connecting the housing cover 16 to the second end plate 46 of the filter element 28. For this purpose, the second end plate 46 comprises an internal thread in which the external thread of the connecting screw 68 engages. When the connecting screw 68 is tightened, the housing cover 16 is pulled in the direction of the housing base 14 by force transmission over the support ring 50, which is axially fixed between the shoulder 60 and the projections, provided that the projections of the retaining tabs 62 engage over the upper edge of the support ring 50. If the filter element 28 is only incompletely inserted and the projections 64 of the retaining tabs 62 abut the radially outer surface of the support ring 50, the retaining tabs 62 are deflected outwardly to such an extent that the housing cover 16 cannot be fitted.

The connecting screw 68 comprises an inner part and an outer part connected by a ratchet coupling forming a torque limiting mechanism 73.

FIGS. 6-8 schematically illustrate a holding member 72 of the air filter 10 according to the invention. The filter housing 12 is configured to provide a series of first structures 74 around the periphery of the filter housing 12, which are substantially block-like protrusions. The holding member 72 is a one-piece, elongated plastic injection molding element and includes a second, claw-like structure 76 at each of its two longitudinal ends. The claw-like structures 76 are configured to engage a respective one of the first structures 76 to positively connect the filter housing 12 to the holding member 72 when assembled. Since a total of 8 of the first structures 76 are evenly distributed over the circumference of the filter housing 12, the holding member 72 can be attached to the filter housing 12 in 8 different positions, each of these positions corresponding to a rotational position of the filter housing 12.

Further, the holding member 72 comprises at least two base structures 78, each disposed below the claw-like second structures 76, for fixing the holding member 72 to a mounting target structure (not shown). The two ends of the holding member 72 are connected by two side walls 80, the lower edge of which facing the mounting target structure is straight and the arcuate upper edge of which follows the curvature of the filter housing 12, so that the filter housing 12 rests on the upper edge in the mounted state.

A length of the holding member 72 in the circumferential direction of the filter housing 12 is smaller than the circumference of the filter housing 12. In the exemplary embodiment shown in FIGS. 6-8, the length is about one third of this circumference.

The holding member 72 can be elastically deformed to create the positive connection between the first structures 74 and the second structures 76, whereby the base structures 78 are tilted against each other, and after snapping the first structures 74 and the second structures 76 into place, the base structures 78 are in their aligned assembly target position. By screwing the holding member 72 into screw holes 82 of the base structures 78 on the mounting target structure, elastic deformation of the holding member 72 necessary to release the positive connection is blocked and a secure connection of the air filter 10 to the mounting target structure is established.

A bending direction of the elastic deformation necessary to make the positive connection is opposed to a curvature direction of the outer periphery of the filter housing 12.

The claw-like second structures 76 are hollow structures each having an opening into which the first structures 74, which are configured as projections, engage.

A central structure 82 of the holding member 72, in the longitudinal direction of the holding member 72, interacts with a projection 74 on the filter housing 12, which is located midway between the two projections 74, which engage in the openings of the second structures 76. The central structure 82 serves to center the holding member 72.

The holding member 72 has end walls 84 in each of its end regions which, when assembled, extend substantially in parallel with the radial and axial directions of the filter housing 12 and which are adapted to engage behind flanks of the two outer first structures 74 remote from a center of the holding member 72.

FIGS. 9a-9d again schematically illustrate the steps for mounting the filter housing 12 to a mounting target structure (FIG. 9d).

In FIG. 9a, the filter housing 12 and the holding member 72 are shown separated from each other.

FIG. 9b shows the holding member 72 in a resiliently deformed configuration upon snapping the second structures 76 over the outer first structures 74 of the filter housing 12, with the center structure 82 centering the holding member relative to the filter housing 12 and mated over a central one of the first structures 72 of the filter housing 12.

FIG. 9c shows the holding member 72 after snapping the second structures 76 over the outer first structures 74 of the filter housing 12, and FIG. 9d shows the filter housing in the assembled configuration at the mounting target structure after screwing mounting screws into the base structures 78.

1. An air filter including a filter element (28), a substantially cylindrical filter housing (12) with an unfiltered air inlet (18) and a filtered air outlet (20) arranged substantially concentrically at a first end face of filter housing (12), wherein an ex-tension tube (22) projecting into the interior of the filter housing (12) and the filter element (28) at the filtered air out-let (20) comprises a first end plate (24) which can be fitted on-to the extension tube (22), wherein the first end plate (24) is made of plastic and comprises a sealing lip (30) which is integrally formed thereon and projects radially inwardly and, in the plugged-on state, bears against the extension tube (22), the first end plate (24) being produced from a non-porous plastic.

2. An air filter according to claim 1,
wherein the sealing lip (30) projects radially inward and axially in the direction of the first end face from a base ring of the first end plate (24).

3. An air filter according to claim 1, wherein the first end plate (24) comprises a spacer structure (40) projecting axially in the direction of the first end face and projecting axially beyond the sealing lip (30).

4. Air filter according to claim 3, wherein the axial height of the spacer structure (40) is selected such that, in an assembled state of the filter element (28), a gap re-mains between the spacer structure (40) and the wall of the filter housing (12).

5. An air filter according to claim 1, wherein the first end plate (24) comprises a second sealing lip (42) which is integrally formed thereon and projects radially outward and, in the fitted state, bears against the attachment tube (22).

6. An air filter according to claim 1,
wherein a support ring (50) arranged on a radially outer surface of the filter element (28) for radially fixing the filter element (28) in the filter housing (12).

7. An air filter according to claim 1, wherein a support ring (50) arranged on a radial outer surface of the filter element (28) for axially fixing the filter element in the filter housing (12).

8. An air filter according to claim 6, wherein the support ring (50) is formed integrally with a second end plate (46), which is arranged at the end of the filter ele-ment (28) opposite the first end plate (24).

9. An air filter according to claim 1, wherein the first end plate (24) is bonded to a filter bellows (48) of the filter element (28).

10. An air filter according to claim 1, wherein the plastic of the first end plate (24) is selected from the group consisting of Polyethylene, polypropylene, acrylonitrile butadiene styrene (ABS), Polyamide (PA), Polylactate (PLA) Polymethyl methacrylate (PMMA), Polycarbonate (PC), Polyethylene terephthalate (PET), Polyethylene (PE), Polypropylene (PP), Polystyrene (PS), polyetheretherketone (PEEK) and Polyvinyl chloride (PVC).

11. A filter element for use in an air filter (10) according to claim 1, wherein the filter element (28) comprises a first end plate (24) which is attachable to the neck tube (22) of the air filter (10), and wherein the first end plate (24) is made of plastic and comprises a sealing lip (30) which is integrally formed thereon, projects radially inwardly and, in the plugged-on state, bears against the extension tube (22).
